(19) United States
(12) Patent Application Publication
(10) Pub. No.: US 2006/0135232 A1
(43) Pub. Date: Jun. 22, 2006

(54) Method and system for delivering advertising content to video games based on game events and gamer activity

(76) Inventor: Daniel Willis, Stittsville (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/303,969

(22) Filed: Dec. 19, 2005

Related U.S. Application Data
(60) Provisional application No. 60/636,537, filed on Dec. 17, 2004.

(51) Int. Cl. A63F 13/00

(52) U.S. Cl. 463/1

(57) ABSTRACT

A method for conditional enabling of advertising spots within an advertising enabled game includes receiving data from an advertising enabled game. In particular, the data relates to each of a plurality of actions in isolation performed by a particular gamer while playing the advertising enabled game. Based on the data, a characteristic relevant to advertising is determined for the particular gamer. In dependence upon the determined characteristic content for being displayed to the gamer is selected.

### REFERENCE TO PRIOR APPLICATION

This application claims benefit from U.S. Provisional application 60/636,537 filed on Dec. 17, 2004, the entire contents of which is incorporated herein by reference.

### FIELD OF THE INVENTION

The instant invention relates generally to advertising in video games, and more particularly to a method and a system for delivering advertising content to video games based on game events and gamer activity.

### BACKGROUND OF THE INVENTION

During recent years, computer gaming has gained increasing popularity, and today thousands of players are playing games all around the world. Predictably, interactive computer gaming has blurred the line between games and other entertainment or communication media, and the avenues that are being explored in the development of gaming might well break new ground for interactive Internet applications in all areas of business relations and social life.

Due to their dynamic nature and specific appeal to certain audiences, video games and especially games played on Internet enabled platforms provide the ideal vehicle for Internet advertising. Not only is it possible for an advertiser to target directly a specific group of customers, but also advertisements optionally are incorporated directly into the computer games, enabling something akin to the well-known concept of product placement. In such a system, a game is running on a video gaming that is connected to the Internet. Throughout the playing of the game, the game software contacts a set of ad servers to retrieve advertising content that is available for being displayed to the gamer during game play. The data and advertising content is transferred using HTTP protocols over the Internet. Optionally, the advertising content is cached locally to the game, and throughout the playing of the game the game software contacts a set of ad servers to retrieve a list of advertising content, selected from the cached advertising content, that is available for display to the gamer during game play.

As in any marketing effort, success depends heavily upon having the ability to identify accurately a target audience. Due to the large number of game types that are currently on the market, the demographic make-up of a game playing audience varies greatly. Accordingly, it would be beneficial to be able to determine the demographic profile of the gamer to be used to enhance the advertisement service provider's ability to offer appropriate exposure for their advertisers.

One way to identify the target audience is simply to ask the audience, in this case a plurality of gamers, for information about themselves. For instance, each gamer as part of the initial installation and/or periodically upon startup of the game, is asked to fill out or update a client survey. The survey is intended to garner information for identifying the demographic profile of the gamer. In some games, multiple players create player ids that are used to log on to the game. When collecting client demographic information within a game, it is desirable to collect player based data so that the demographic profile of a current player is reflected. The player profile is then used to influence which ad content to use during a current game session. Of course, anytime data is collected there are justifiable privacy concerns, so care must be taken to ensure no personally identifiable information is collected. Furthermore, the survey itself must be age appropriate. In addition, this scheme relies heavily upon gamer honesty. For instance, there is nothing to prevent a 15 year-old male gamer from identifying himself as a 43 year-old female gamer.

As with any public forum, there are those who want to limit the type of content that is provided to a particular audience. One major interest group is that of parents, wishing to ensure that their children are not exposed to inappropriate content. Parental controls already exist in the world of television and Internet access, and similar controls are applicable to Internet enabled advertising as well. In the case of an Internet advertising enabled game for kids, parents upon installation use parental controls to restrict the ad content that is received. For instance, the parent activates filters to prevent the downloading of inappropriately categorized ad content promoting alcohol, tobacco and sex.

Naturally, an advertiser does not want to waste advertising dollars on impressions to an uninterested gaming audience. Furthermore, an advertiser typically is willing to pay a premium for highly targeted marketing campaigns to a smaller but very interested audience. Therefore, impressions resulting from content that satisfies the gamer-specified content filters are counted distinctly from those that do not match, allowing the numbers to be reported separately and charged appropriately. Provided that the filter criteria match the requirements of the advertisers, adoption of gamer-specified content filters results in higher revenue per spot.

Content filters are therefore built on criteria jointly provided by the advertising broker, the advertisement service provider, the game producer and the gamer. However, in the event that content hosted by the advertisement service provider does not satisfy the gamer-specified content filters, the advertisement service provider optionally returns other content scheduled for the spot, if permitted by the advertiser, or returns nothing in which case default content for the spot is used.

Another way to identify the target audience is by analyzing gamer activity. Within a game there are many events, some of which are more significant than others. Events occurring at certain points in a game, such as a character dying, a gamer initiating pause, a gamer reaching certain strategic levels within the game etc., provide additional opportunities for displaying certain types of advertising content. Categorizing game events supports providing an inventory of advertising spots for being sold to advertisers, for the purpose of displaying advertising content. Accordingly, selecting spots according to occurrences within a game is yet another basis upon which advertisers are able to select spots for displaying their advertisements. It would be advantageous to provide a method and system for delivering advertising content in dependence upon events occurring in the game and/or gamer skill and preferences.

### SUMMARY OF THE INVENTION

It is an object of at least one embodiment of the instant invention to link advertising sites with gaming sites to allow for specific and dynamic combinations of targeted advertisements with a proper advertising environment.

In accordance with an aspect of the instant invention there is provided a method for conditional enabling of advertising spots within an advertising enabled game, comprising: receiving data from an advertising enabled game, the data relating to previous actions performed by a particular gamer while playing the advertising enabled game; identifying a pattern in the data, the pattern indicative of one of a behavioral tendency and a preference of the particular gamer; and, selecting content for being displayed to the particular gamer based upon the identified pattern in the data.

In accordance with another aspect of the instant invention there is provided a method for conditional enabling of advertising spots within an advertising enabled game, comprising: providing a package for interacting with an advertising enabled game during a gaming session, the package comprising computer-readable code for gathering and storing information relating to gamer activity during the gaming session; receiving a transmission of data from the advertising enabled game, the data including the information relating to gamer activity; analyzing the data according to a processing algorithm; determining a characteristic of the gamer that is relevant to advertising, the determination based on the analysis; and, selecting content for being displayed to the gamer in dependence upon the determined characteristic.

In accordance with another aspect of the instant invention there is provided a method for conditional enabling of advertising spots within an advertising enabled game, comprising: initiating an advertising enabled game on an online enabled platform; during a period of game play, gathering information relating to an outcome of an event within the advertising enabled game, the outcome influenced by the way in which a particular gamer interacts with an element of the advertising enabled game; at a time, providing the gathered information to a server for analysis; using a processing algorithm of the server, analyzing the gathered information to determine a characteristic of the particular gamer that is relevant to advertising; and, selecting content for being displayed to the particular gamer in dependence upon the determined characteristic.

In accordance with another aspect of the instant invention there is provided a method for conditional enabling of advertising spots within an advertising enabled game, comprising: receiving data from an advertising enabled game, the data relating to each of a plurality of actions in isolation performed by a particular gamer while playing the advertising enabled game; based on the data, determining a characteristic relevant to advertising for the particular gamer; and, selecting content for being displayed to the gamer in dependence upon the determined characteristic.

In accordance with an aspect of the instant invention there is provided a broker mediated advertisable gaming environment having gaming sites and advertising sites connected to an internet protocol wide area network. The gaming environment comprises a broker site connected to an internet protocol wide area network for registering games provided from gaming sites and for licensing registered games for advertising to advertising sites, whereby the broker site maintains an inventory of characteristics of registered games, the characteristics relevant for advertising.

In accordance with another aspect of the instant invention there is provided a method for categorizing game events and gamer skills and/or proficiencies and/or preferences for allowing an advertising broker and an advertiser to appropriately select spots for placing advertisements. Preferably, the categorizing of advertising spot is done according to a set of criteria mutually agreed upon by the advertiser, the advertising broker and a game producer/publisher.

In accordance with another aspect of the instant invention there is provided a method for categorizing game events and gamer skills and/or proficiencies and/or preferences for allowing an advertising broker and an advertising service provider to appropriately select spots for placing advertisements. Preferably, the categorizing of advertising spot is done according to a set of criteria mutually agreed upon by the advertising service provider, the advertising broker and a game producer/publisher.

In accordance with another aspect of the instant invention there is provided a method for inferring cultural context for allowing an advertising broker and an advertiser to appropriately select spots for placing advertisements.

In accordance with another aspect of the instant invention there is provided a method for optionally collecting gamer survey data prior to game invocation.

In accordance with another aspect of the instant invention there is provided a method for using gamer specified content filters to serve up ad content based on the content filter information.

In accordance with another aspect of the instant invention there is provided a method for counting impressions matching gamer specified content filters independently of non-matching or unfiltered impressions.

### BRIEF DESCRIPTION OF THE DRAWINGS

Embodiments of the instant invention will now be described in conjunction with the following drawings, in which

FIG. 1 is a high-level block diagram of a broker mediated advertisable gaming system;

FIG. 2 is a simplified flow diagram of a method according to an embodiment of the instant invention;

FIG. 3 is a simplified flow diagram of another method according to an embodiment of the instant invention;

FIG. 4 is a simplified flow diagram of still another method according to an embodiment of the instant invention; and,

FIG. 5 is a simplified flow diagram of still another method according to an embodiment of the instant invention.

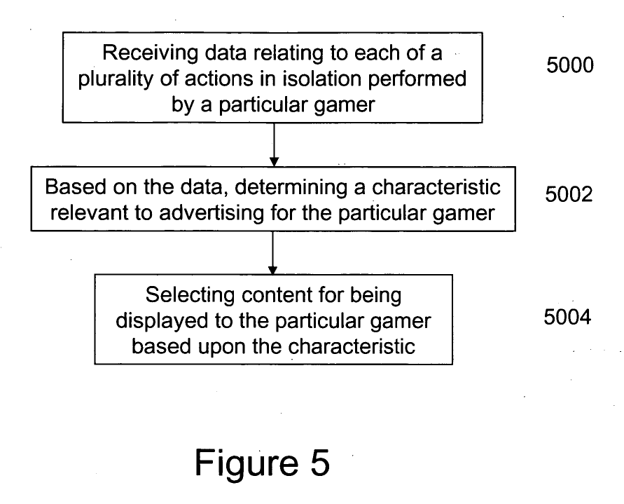

### DETAILED DESCRIPTION OF EMBODIMENTS OF THE INVENTION

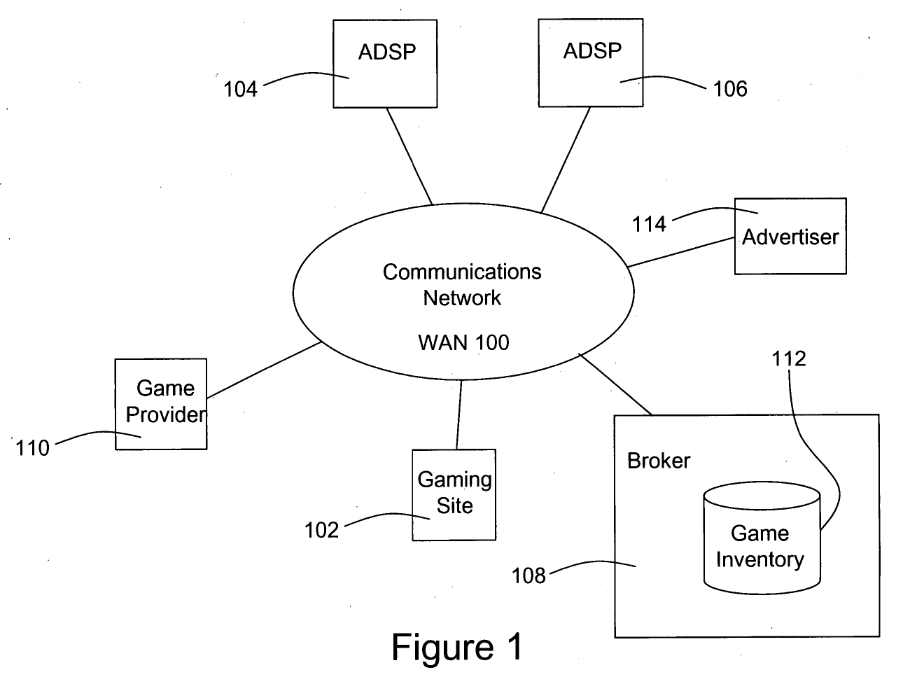

Referring to FIG. 1, shown is a high-level block diagram of a broker mediated advertisable gaming system. A computer system of gaming site 102 is connected to a communications network, for instance Internet Protocol Wide Area Network (WAN) 100. Advertising service provider (ADSP) 104 and ADSP 106 also are connected to WAN 100. ADSP 104 and ADSP 106 implement one or more ad campaigns at a time. In the case of plural ad campaigns, ADSP 104 and ADSP 106 each schedule delivery of advertising content that is provided by different advertisers, to a limited number of available spots within instances of a game at gaming site 102. Clearly, it is a complex task managing and scheduling advertising content that is selected from a plurality of different advertising campaigns, which are being implemented by a plurality of ADSPs, for display at spots appearing within instances of a game at gaming site 102. Advertising broker site 108, which also is connected to WAN 100, acts as an intermediary between the plurality of ADSPs and gaming site 102, as described for instance in U.S. Provisional Patent Application 60/636,543, filed on Dec. 17, 2004 and in a co-pending United States Patent Application claiming priority therefrom and filed on Dec. 19, 2005, the entire contents of both of which are incorporated herein by reference.

A game provider 110 also is connected to WAN 100. The game provider 110 provides an advertising enabled game. For instance, when the game is in execution on a computer system of gaming site 102, information relevant to advertising is provided to the game via WAN 100, from one or both of ADSP 104 and ADSP 106. Based on the provided information, advertising content is displayed at spots within game instances of the advertising enabled game.

Referring still to FIG. 1, when an advertising enabled game is initiated on gaming site 102, the game establishes communication with the advertising broker site 108 via WAN 100 in order to determine which one of ADSP 104 and ADSP 106 to contact for information regarding available advertising content. The advertising broker site 108 returns a message including an address for the specific ADSP that the game is to contact. The game 102 retrieves from the specific ADSP a list of available advertising content. For instance, in the instant, non-limiting example it is assumed that advertising broker site 108 returns the address of ADSP 104 to game 102, and so game 102 contacts ADSP 104 to retrieve the list of available advertising content.

In a first approach for conditional enabling of a given spot based on game events, the game provider 110 programmatically provides predefined conditions as to when content is shown or not shown. These conditions must be described in a catalog of spots, which is maintained for instance by advertising broker site 108, and which is accessible by advertiser 114. The catalog of spots is described in greater detail in U.S. Provisional Patent Application 60/636,542, filed on Dec. 17, 2004 and in a co-pending United States Patent Application claiming priority therefrom and filed on Dec. 19, 2005, the entire contents of both of which are incorporated herein by reference. During game play, the game determines which of the predefined conditions are met, and reports the results of the determination to a server. The next time the game requests a list of available advertising content, the content that is provided is selected in dependence upon which of the predefined conditions have been met. Optionally, the game determines which of the predefined conditions are met, and caches the results of the determination locally. In this case, the game selects a subset of advertising content for delivery from a list of available content, based upon which of the predefined conditions have been met. Unfortunately, typically there is a lengthy delay between a game being developed and seeing the game in widespread distribution. For instance, the game product must be completed, tested, debugged, potentially certified, packaged, marketed and distributed. Accordingly, the advertiser is forced to either expend resources months or years before an ad campaign is to be run, or accept less flexibility in a final product that offers only game provider-defined conditions.

In a second approach for conditional enabling of a given spot based on game events, the content shown in a spot is conditionally enabled by gaming conditions that are affected by actions on the part of the gamer. In such an approach, typically the advertiser 114 determines the enabling conditions rather than merely accepting conditions that are predefined by, for instance, game provider 110. If the advertiser 114 requires access to conditions such as a current time in the game's virtual world, then the game provider 110 must support a mechanism, such as scripting, to allow advertiser 114 to specify desired conditions, and which can subsequently be interpreted by a game instance on gaming site 102.

According to the second approach an “advertising toolkit” is embedded in the game at some time after the game is developed. This “advertising toolkit” supports functions of the game including content request initiation, reporting of impressions from the game, etc. The “advertising toolkit” also supports gathering and delivery of a comprehensive set of metrics relating to gaming conditions. For instance, a plurality of ad spots is defined within the game. Each ad spot is for presenting an impression of advertising content to the gamer when the gamer navigates to that ad spot. For instance, in a first-person shooter game the gamer navigates to an ad spot by causing the game character to walk within view of an ad spot. In an auto racing game, the gamer navigates to an ad spot by “driving” a virtual car past an add spot, etc. As game play progresses, each impression served to the gamer is recorded along with other information relating to at least one of a location within the game of the spot that served the impression, the virtual or real-world time at which the impression was served, the frequency of impressions served by the spot, the length of time the gamer was exposed to the impression, whether the impression was obstructed by objects in the game, etc. Of course, in practice some ad spots are populated with actual advertising content whilst other ad spots are not. In particular, default content or a blank or patterned area appears at ad spots that are not populated with actual advertising content. Nevertheless, according to the second approach, the game enumerates an impression for default content, etc. along with other information as described above. Accordingly, the ad spots serve dual roles as virtual display devices as well as a sort of closed-circuit camera system within the virtual environment of the game. Anytime the “gamer” in the virtual world comes within view of an ad spot “camera”, their “presence” is registered by counting an impression. As the “gamer” moves from place to place in the virtual world, they leave the field of view of one ad spot “camera” and eventually enter the field of view of another ad spot “camera,” or re-enter the field of view of the same ad spot “camera.”

Optionally, custom metrics are supported for determining information relating to style of game play, advancement to higher levels, or other performance-based information. For instance, performance-based information is derived from a game status identifier of the gamer, such as a count of bullets remaining, health level or number of enemies “killed” etc. in the case of a first person shooter game, fuel level remaining, number of collisions, or automobile condition etc. in a racing game, etc. The performance based-information is derived from values that are already determined by the game during game play, and so does not require the game to perform any additional calculations or determinations.

The comprehensive set of metrics is gathered over a period of time as game play continues. Accordingly, the set of metrics is useful for determining certain tendencies of the gamer, as well as certain demographic information relating to the gamer. To this end, the game provides the comprehensive set of metrics to a server for processing thereby. Typically, the game provides the comprehensive set of metrics gathered during a previous gaming session at the start of a next gaming session. Optionally, update reports continue to be provided to the server periodically during the current gaming session. The type of information that is obtained in this manner varies depending upon factors including the nature of custom metrics, if any, the processing algorithm applied to the comprehensive set of metrics, etc. Several specific and non-limiting examples are discussed in greater detail, below.

### EXAMPLE 1

A gamer, having purchased software relating to a first-person shooter game, initiates a game instance on an advertising enabled gaming platform. Game play progresses rapidly from level to level and the gamer does not spend significant time at any particular place in the game. The metrics that are reported from the game to a remote server are analyzed according to a processing algorithm, and it is determined that the difficulty of the game is not sufficiently high to challenge the particular gamer. Clearly, this situation benefits no one. The gamer becomes bored and disinterested in the game and so feels unsatisfied. In addition, advertisement impressions to the gamer are of low value since the gamer moves quickly and so the duration of the impression likely is short. Furthermore, feeling that money has been wasted on a game that is too easy, the gamer is unlikely to be receptive to most advertising content. That being said, the gamer likely is receptive to advertising content relating to a more challenging game, or to advertising content including a coupon redeemable for trading up to a more challenging version of the same game or a more challenging game title. Advantageously, the comprehensive set of metrics enables making an estimation of the skill level of the gamer, which in turn allows an advertising service provider to provide advertising content relating only to those titles that are most appropriate for that particular gamer. If the gamer acts upon such an impression, then everyone benefits. The gamer finds more challenging game play in the new game, and the advertiser associated with the new game makes an additional sale.

### EXAMPLE 2

A gamer, having purchased software relating to a fantasy role-playing game, initiates a game instance on an advertising enabled gaming platform. Game play progresses slowly. Specifically, the gamer encounters challenges that are appropriate given their skill level up to a particular point, but is unable to progress beyond the particular point. For instance, the gamer repeatedly fails a challenge that is presented at the particular point. This situation also likely benefits no one. Advantageously, the comprehensive set of metrics provides an indication that the gamer requires a hint in order to advance past the particular spot in the game. This information is very useful to the advertising service provider. For instance, using an ad spot that is encountered either before or at the particular point, the advertising service provider provides a “hint-ad.” For example, the ad spot displays a message such as “Click here for a hint,” or “Enter to receive a hint.” If the gamer accepts the invitation, then advertising content is displayed, either in the form of media contained within the spot, or by switching to a full screen view temporarily during the “hint-ad” deliver portion. Optionally, the advertising content contains a message such as for instance “This hint brought to you by Advertiser A,” or “This hint sponsored by Advertiser A,” etc. After the ad impression is served, the gamer receives a hint, enabling the gamer to progress past the challenge. Advantageously, by removing the gamer from active game play in this manner, the game is less likely to be distracted and more likely to pay full attention to the advertising content. Furthermore, the gamer is very interested in the hint that is to follow the advertising spot or alternatively embedded therein, and so they are likely to pay close attention even during display of the advertising content. Alternatively, the ad spot is used to display advertising content for game tutorials, for games more appropriate to the gamer's current skill level, etc. Optionally, the gamer carries with them a “hint scroll” or similar virtual item that is usable at any point in the game world, provided content is available for delivery. Using the hint scroll optionally suspends game-play and/or opens up a separate screen or frame for viewing what is “written” on the hint scroll. Advertising content optionally is displayed prior to providing the hint, or the logo of an advertiser is incorporated into the scroll design, such as for instance as a virtual “watermark” or within a margin area of the scroll.

### EXAMPLE 3

A gamer, having purchased software relating to an auto racing game, initiates a game instance on an advertising enabled gaming platform. Game play progresses, during which the gamer makes numerous decisions based on preference for different types of products in the game. Preferably, the gamer is faced with making a choice between two mutually exclusive game elements, wherein game elements are for instance virtual representation of real-life branded or non-branded products. Advantageously, the comprehensive set of metrics provides an indication of the choices the gamer makes during game play. This information is very useful to the advertising service provider, the advertiser, etc. For instance, the gamer selects a yellow car out of all possible colour choices. If the gamer has a preference for the colour yellow, indicated by selecting yellow items a plurality of times, then likely it is advantageous to shift the colour scheme of advertising content displayed to that gamer so as to reflect this preference and or to be highly noticeable within this colour scheme. If the gamer uses a proportionately large portion of an allotted budget to customize wheel rims of the virtual car, then likely the gamer is more receptive to advertising content relating to custom car parts and more specifically wheel rims.

Of course, gamers are presented with similar choices in other types of games. For instance, in a first-person shooter game the gamer must choose at one point whether to use a snowboard or a pair of skis in order to escape an enemy in an outdoor winter-time environment. If the gamer selects skis, then advertising content relating to skis, ski bindings, ski poles, etc. is displayed.

### EXAMPLE 4

A gamer, having purchased software relating to a first-person shooter game, initiates a game instance on an advertising enabled gaming platform. Game play progresses, with the gamer routinely shooting enemies multiple times and even after the enemy is “dead,” shooting “innocents” in the game, favouring “overkill” weapons such as rocket launchers and explosives when a simple machine gun would suffice, etc. Advantageously, the comprehensive set of metrics provides an indication relating to a pattern of play for the particular gamer. This information is very useful to the advertising service provider, the advertiser, etc. For instance, when psychological or survey studies establish a connection between game play patterns and demographic information relating to gamers. Comparing the information relating to game play patterns of a particular gamer, as determined by analyzing the comprehensive set of metrics provided from the game, to results of a relevant psychological or survey study, yields likely demographic information relating to the particular gamer. Based on the game play described above, study results indicate, for instance, that the particular gamer is male, middle-class, aged 15-19, etc. Selection of advertising content for display to the particular gamer is based upon the determined demographic information, such that ads targeting 25-31 year old female are excluded, for instance. Furthermore, the game play patterns of a particular gamer are useful for selecting appropriate advertising content even absent knowledge of demographic information. For instance, based upon the game play described above, the particular gamer likely will be more receptive to advertising content relating to action movies.

### EXAMPLE 5

A gamer, having purchased software relating to a fantasy role-playing game, initiates a game instance on an advertising enabled gaming platform. Game play progresses, with the gamer dealing adequately with challenges and obstacles as they are encountered. During game play, impressions are served for one or more pieces of advertising content using one or more advertising spots of the game. For instance, some of the impressions relate to different advertising content displayed using a same ad spot, some of the impressions relate to advertising content displayed using a dedicated ad spot, and some of the impressions relate to multiple impressions for same advertising content, either as a result of the gamer passing the same dedicated ad spot numerous times, or as a result of same advertising content being displayed using different ad spots as the gamer “moves” about the game environment. The comprehensive set of metrics that is gathered reflects not only the number of impressions served for different pieces of advertising content, but also the duration of each impression, whether or not the gamer interacted with a particular piece of information, whether or not the gamer returned to a particular ad spot to view the impression multiple times, and if so the duration of each impression, etc. Analyzing the comprehensive set of metrics provides an indication of which advertising content had the greatest impact on the gamer. If metric update reports are provided from the game during a gaming session in progress, then this analysis allows an advertising service provider to modify a list of content available for display within the game, so as to weight the content in favour of more ads that the gamer has expressed an interest in, additional ads relating to an advertiser if the gamer has shown interest in other ads for that advertiser, ads incorporating offers for free samples or coupons relating to a product in which the gamer has expressed interest, etc. Since it is determined that the gamer is a suitable target for particular ads, an advertiser is more likely to pay a premium advertising rate for immediate additional advertising content delivery, so as to “strike when the iron is hot” at a time the attention of the gamer has been caught. Conversely, if an advertiser has an advertising campaign including a plurality of different pieces of advertising content for being displayed at different spots within a game, then the advertiser likely would want to cancel additional advertising content delivery to a particular gamer if it is determined that the gamer is not expressing significant interest in the advertising content that has been delivered prior to the metric update report being spent. The advertiser's resources would be better-spent providing impressions to different gamers, or providing impressions to the gamer at a different time, when the gamer is more receptive to the advertising message of the ad campaign.

Additionally, there is an abundance of other information that can be inferred from the manner in which the game is played and the game state. For example, the game progression rate indicates the level and type of player, the number of secrets found also reveals information, the response time of a gamer, the experience or skill level the game is played at, the success rate of overcoming or destroying obstacles also indicate level and type of play. By analyzing such information the player is categorized with the result that different advertisements are presented to different based on their particular categorization.

Furthermore, cultural context optionally is determined by having the game provider 110 add non-critical secrets and puzzles to be solved by the gamer using knowledge acquired externally to the game. For instance, the gamer needs to interact with a particular ad spot of the game and enter the name of a magic spell, either by spelling the name or by selecting the name from a list. For example, the name of a spell that is needed to enter a particular room might only be mentioned in a movie that the gamer must have seen if they are to know the name of the spell. Of course, the gamer still is able to use the spell if the spell is critical to game play, but simply does not know the name of the spell. Optionally, enhanced content is provided when the gamer knows the name of the spell compared to when the gamer merely uses the spell without knowing the name of the spell. By successfully solving such problems, the gamer provides valuable additional information that is useful for tuning which pieces of advertising content to display in subsequent spots. For example, promoting a movie is unnecessary if the player has already seen it and entered the name of the spell as it was revealed therein. Of course, optionally such problems are provided using advertising spots rather than being programmatically defined during the game building process. In that case, content is displayed using an advertising spot within the game. For instance, the content includes a question, such as “what is the name of the spell required to enter this room?” The gamer “clicks on” or otherwise indicates a name selected from a list of names that is provided below the question.

Additionally, metrics relating to other gaming conditions not associated directly with the actions of the gamer are delivered from the game to the server. For instance, the time or date in either the game world or in the real world of the gamer are useful pieces of information for managing advertising content delivery. For example, a take-out pizza establishment might be interested in advertising in games after 10:00 pm local time, in any game session that has exceeded three hours.

Of course, demographic information relating to a gamer optionally is obtained in other ways, such as for instance having the gamer fill out a survey the first time an advertising enabled game is initialized, and/or at intervals of time. The game collects the gamer demographic information and stores a locally persistent copy for each gamer, which optionally is subsequently modified. At the start of a gaming session, the advertising enabled game communicates with a remote server to obtain information relating to advertising content that is available for display within ad spots of the game. The game also communicates filter specifications resulting from the gamer demographic and survey information it has stored, whereupon the server selects a list of content that satisfies the gamer specified content filters. In other words, the server determines whether the gamer has provided demographic information that satisfies criteria established by advertisers. For instance, an advertiser specifies that their advertising content is for display only to gamers under a certain age, or only to female gamers, etc. In the event that no advertising content is available having advertiser established criteria that matches the gamer specified content filters, the server optionally selects other content that has not been flagged by an advertiser as being restricted to a certain demographic. A list of advertising content selected by the server is then returned to the game.

During a gaming session the game independently enumerates the number of impressions made by content during the game session that does or does not match the gamer specified filter. Upon terminating a gaming session, or upon re-initializing a new gaming session, the game submits to the server the number of impressions enumerated previously, for reporting to advertising service providers, etc., including a breakdown of the types of impressions.

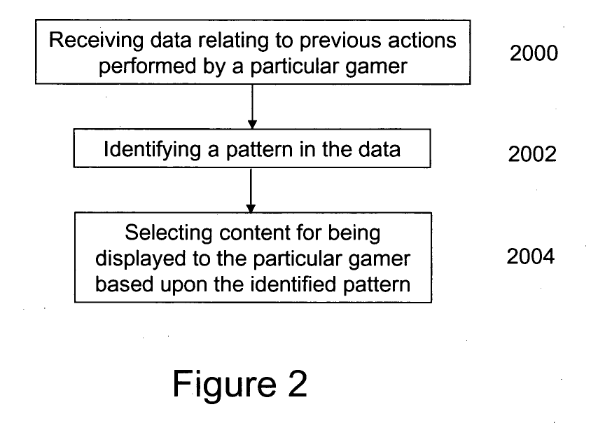

Referring now to FIG. 2, shown is a simplified flow diagram of a method according to an embodiment of the instant invention. At step 2000 data relating to previous actions performed by a particular gamer, while playing the advertising enabled game, are received from an advertising enabled game. At step 2002, a pattern in the data is identified, the pattern indicative of one of a behavioral tendency and a preference of the particular gamer. At step 2004 content is selected for being displayed to the particular gamer based upon the identified pattern in the data.

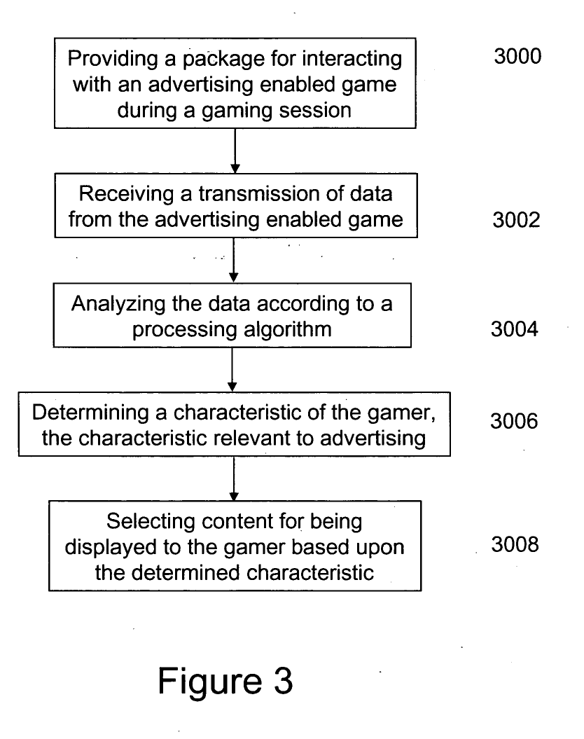

Referring now to FIG. 3, shown is a simplified flow diagram of a method according to an embodiment of the instant invention. At step 3000 a package is provided for interacting with an advertising enabled game during a gaming session, the package comprising computer-readable code for gathering and storing information relating to gamer activity during the gaming session. At step 3002 a transmission of data from the advertising enabled game is received, the data including the information relating to gamer activity. At step 3004, the data is analyzed according to a processing algorithm. At step 3006 a characteristic of the gamer is determined, the characteristic relevant to advertising. In particular, the determination is based on the analysis. At step 3008 content is selected for being displayed to the gamer in dependence upon the determined characteristic.

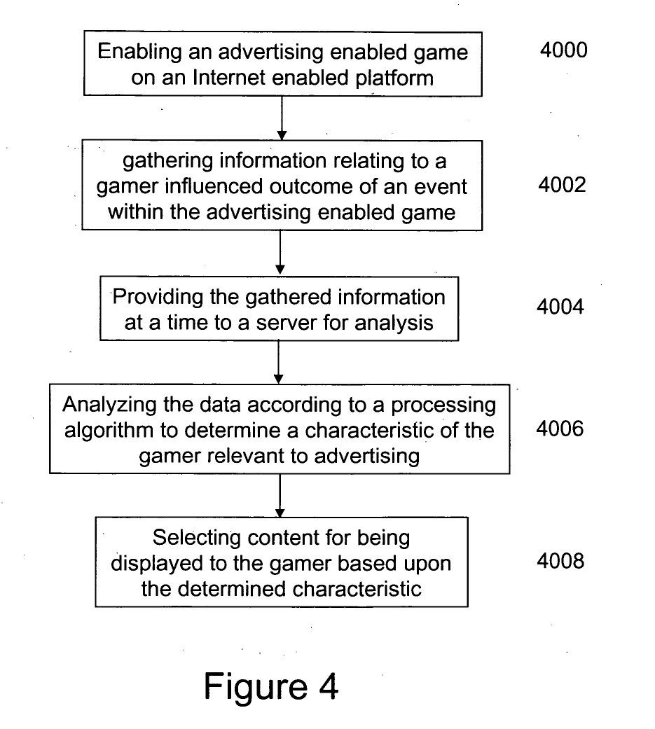

Referring now to FIG. 4, shown is a simplified flow diagram of a method according to an embodiment of the instant invention. At step 4000 an advertising enabled game is enabled on an online enabled platform. At step 4002, during a period of game play, information is gathered relating to an outcome of an event within the advertising enabled game, the outcome influenced by the way in which a particular gamer interacts with an element of the advertising enabled game. At step 4004 the gathered information is provided at a time to a server for analysis. At step 4006 a processing algorithm of the server is used to analyze the gathered information to determine a characteristic of the particular gamer that is relevant to advertising. At step 4008 content is selected for being displayed to the particular gamer in dependence upon the determined characteristic.

Referring now to FIG. 4, shown is a simplified flow diagram of a method according to an embodiment of the instant invention. At step 5000 data is received from an advertising enabled game, the data relating to each of a plurality of actions in isolation performed by a particular gamer while playing the advertising enabled game. At step 5002, a characteristic relevant to advertising is determined for the particular gamer, based on the data. At step 5004 content for being displayed to the gamer is selected in dependence upon the determined characteristic.

Numerous other embodiments may be envisaged without departing from the spirit and scope of the instant invention. All specific examples have been provided for illustrative purposes only and are not intended to be limiting in any way.

What is claimed is:

1. A method for conditional enabling of advertising spots within an advertising enabled game, comprising:
receiving data from an advertising enabled game, the data relating to previous actions performed by a particular gamer while playing the advertising enabled game;
identifying a pattern in the data, the pattern indicative of one of a behavioral tendency and a preference of the particular gamer; and,
selecting content for being displayed to the particular gamer based upon the identified pattern in the data.

2. A method according to claim 1, wherein the data comprises data relating to each one of a plurality of previous actions in isolation, the plurality of previous actions performed by a particular gamer while playing the advertising enabled game.

3. A method according to claim 2, comprising identifying the pattern in the data based on data relating to a selected subset of the plurality of previous actions.

4. A method according to claim 3, wherein identifying a pattern comprises applying statistical processing to the data relating to a selected subset of the plurality of previous actions.

5. A method according to claim 1, wherein identifying a pattern comprises analyzing the data according to a first process.

6. A method according to claim 5, wherein analyzing is performed at a location remote from a video gaming system on which the advertising enabled game is in execution.

7. A method according to claim 5, wherein the first process is a statistical process.

8. A method according to claim 1, wherein the previous actions include navigating to an advertising spot of the advertising enabled game.

9. A method according to claim 8, wherein the data relating to previous actions includes data indicative of at least one of: a location of the advertising spot within the game; an identification of content presented to the gamer by the advertising spot; the duration of presentation of content to the gamer by the advertising spot; a real-world local time of presentation of content to the gamer by the advertising spot; a virtual-world local time of presentation of content to the gamer by the advertising spot; the number of content presentations the spot has made to the gamer, an interaction event between the gamer and the content delivered by the spot; and, a game status identifier of the gamer at a time of navigating to the advertising spot.

10. A method according to claim 8, comprising registering an impression served by the advertising spot, and in dependence thereon, retrievably storing data indicative of the impression and a location within the game of the advertising spot.

11. A method according to claim 10, wherein registering an impression served by the advertising spot is performed regardless of whether the advertising spot is populated with a piece of advertising content or a piece of default content.

12. A method according to claim 1, wherein the previous actions include advancing from one level of the advertising enabled game to a next higher level of the advertising enabled game.

13. A method according to claim 1, wherein the previous actions include failure to overcome successfully one of a challenge and an obstacle to advancement within the advertising enabled game.

14. A method according to claim 1, wherein the previous actions include selecting one element of the advertising enabled game in preference to another element of the advertising enabled game.

15. A method according to claim 1, wherein the previous actions include overcoming successfully one of a challenge and an obstacle to advancement within the advertising enabled game.

16. A method according to claim 15, wherein a manner in which the one of a challenge and an obstacle to advancement within the advertising enabled game is overcome successfully is indicative of a style of game play of the gamer.

17. A method according to claim 1, wherein the previous actions include a gamer demonstrating prior knowledge that is derivable from a real world experience.

18. A method according to claim 1, wherein selecting content for being displayed to the particular gamer comprises selecting a piece of advertising content.

19. A method according to claim 18, wherein the piece of advertising content relates to one of a product and a service, and includes one of a coupon, a link to additional content, and information relating to a trial offer for the one of a product and a service.

20. A method according to claim 19, wherein the piece of advertising content is provided in dependence upon the particular gamer having shown an interest in the product or service at an earlier stage of game play.

21. A method according to claim 1, wherein selecting content for being displayed to the particular gamer comprises selecting a piece of advertising content as well as a hint relating to the advertising enabled game.

22. A method according to claim 1, wherein the behavioral tendency of the particular gamer relates to a level of game playing proficiency of the particular gamer.

23. A method according to claim 1, wherein the behavioral tendency of the particular gamer relates to a game playing style of the particular gamer.

24. A method according to claim 1, wherein the preference of the particular gamer is inferred from a choice the gamer made between two mutually exclusive game elements at an earlier stage of game play.

25. A method for conditional enabling of advertising spots within an advertising enabled game, comprising:
providing a package for interacting with an advertising enabled game during a gaming session, the package comprising computer-readable code for gathering and storing information relating to gamer activity during the gaming session;
receiving a transmission of data from the advertising enabled game, the data including the information relating to gamer activity;
analyzing the data according to a processing algorithm;
determining a characteristic of the gamer that is relevant to advertising, the determination based on the analysis; and,
selecting content for being displayed to the gamer in dependence upon the determined characteristic.

26. A method according to claim 25, wherein the information relating to gamer activity comprises a comprehensive set of metrics relating to a gamer activity pattern during a period of game play.

27. A method according to claim 26, wherein the gamer activity pattern during a period of game play includes a plurality of gamer activities performed in isolation during the period of game play.

28. A method according to claim 27, wherein identifying a pattern in the data is performed based on data relating to a selected subset of the plurality of gamer activities.

29. A method according to claim 28, wherein identifying a pattern comprises applying statistical processing to the data relating to a selected subset of the plurality of gamer activities.

30. A method according to claim 26, wherein the comprehensive set of metrics includes data relating to each one of a plurality of gamer activities performed in isolation during the period of game play.

31. A method according to claim 30, wherein identifying a pattern in the data is performed based on data relating to a selected subset of the plurality of gamer activities.

32. A method according to claim 31, wherein identifying a pattern comprises applying statistical processing to the data relating to a selected subset of the plurality of gamer activities.

33. A method according to claim 26, wherein the gamer activity pattern is defined by a pattern of impressions served by a plurality of advertising spots within the game.

34. A method according to claim 33, wherein the comprehensive set of metrics includes data specific to each impression served during the period of game play.

35. A method according to claim 34, comprising obtaining a reduced set of metrics including data specific to a portion of the impressions served during the period of game play.

36. A method according to claim 33, wherein the comprehensive set of metrics includes location data for each advertising spot of the plurality of advertising spots within the game.

37. A method according to claim 33, wherein the comprehensive set of metrics includes for each impression served, data that is indicative of impression content.

38. A method according to claim 33, wherein the comprehensive set of metrics includes for each impression served, data that is indicative of a duration of the impression.

39. A method according to claim 33, wherein the comprehensive set of metrics includes for each impression served, data that is indicative of a real-world local time of the impression.

40. A method according to claim 33, wherein the comprehensive set of metrics includes for each impression served, data that is indicative of a virtual-world local time of the impression.

41. A method according to claim 33, wherein the comprehensive set of metrics includes for each impression served, data that is indicative of an interaction event between the gamer and the impression content.

42. A method according to claim 33, wherein the comprehensive set of metrics includes for each impression served, data that is indicative of a game status identifier of the gamer at the time the impression is served.

43. A method for conditional enabling of advertising spots within an advertising enabled game, comprising:
initiating an advertising enabled game on an online enabled platform;
during a period of game play, gathering information relating to an outcome of an event within the advertising enabled game, the outcome influenced by the way in which a particular gamer interacts with an element of the advertising enabled game;
at a time, providing the gathered information to a server for analysis;
using a processing algorithm of the server, analyzing the gathered information to determine a characteristic of the particular gamer that is relevant to advertising; and,
selecting content for being displayed to the particular gamer in dependence upon the determined characteristic.

44. A method according to claim 43, wherein the event within the advertising enabled game comprises navigating to an advertising spot of the advertising enabled game such that an impression is served.

45. A method according to claim 44, wherein the rate at which the gamer moves past the advertising spot in the game influences the outcome of the event in terms of the duration of the impression.

46. A method according to claim 43, wherein the event within the advertising enabled game comprises encountering one of a challenge and an obstacle to advancement within the advertising enabled game.

47. A method according to claim 43, wherein the event within the advertising enabled game comprises being presented with a choice of selecting one element of the advertising enabled game in preference to another element of the advertising enabled game.

48. A method according to claim 43, wherein selecting content for being displayed to the particular gamer comprises selecting a piece of advertising content.

49. A method according to claim 48, wherein the piece of advertising content relates to one of a product and a service, and includes one of a coupon, a link to additional content, and information relating to a trial offer for the one of a product and a service.

50. A method according to claim 49, wherein the piece of advertising content is provided in dependence upon the particular gamer having shown an interest in the product or service at an earlier stage of game play.

51. A method according to claim 43, wherein selecting content for being displayed to the particular gamer comprises selecting a piece of advertising content as well as a hint relating to the advertising enabled game.

52. A method for conditional enabling of advertising spots within an advertising enabled game, comprising:
receiving data from an advertising enabled game, the data relating to each of a plurality of actions in isolation performed by a particular gamer while playing the advertising enabled game;
based on the data, determining a characteristic relevant to advertising for the particular gamer; and,
selecting content for being displayed to the gamer in dependence upon the determined characteristic.

53. A method according to claim 52, wherein determining a characteristic is performed by applying statistical processing to the data.

54. A method according to claim 52, comprising selecting a subset of the data including data relating to selected ones of the plurality of actions in isolation.

55. A method according to claim 54, wherein the subset of data is selected according to an action type.
